(19) United States
(12) Patent Application Publication
(10) Pub. No.: US 2020/0342823 A1
(43) Pub. Date: Oct. 29, 2020

(54) METHOD FOR DRIVING PIXEL MATRIX AND DISPLAY DEVICE

(71) Applicant: Xianyang Caihong Optoelectronics Technology Co.,Ltd, XIANYANG (CN)

(72) Inventors: YUAN-LIANG WU, XIANYANG (CN); ZHUO LI, XIANYANG (CN); HAIYAN KANG, XIANYANG (CN)

(21) Appl. No.: 16/391,410

(22) Filed: Apr. 23, 2019

(51) Int. Cl. G09G 3/36

(52) U.S. Cl. CPC G09G 3/3607; G09G 3/3696; G09G 3/3614; G09G 3/3674; G09G 2320/0233; G09G 2310/021; G09G 2310/08; G09G 2320/0242; G09G 2320/0209; G09G 3/3685

(57) ABSTRACT

The present invention discloses a method for driving a pixel matrix, the pixel matrix includes a plurality of sub-pixels arranged in a matrix, the method including: receiving an image data, and acquiring original pixel data according to the image data; generating a first driving voltage and a second driving voltage according to the original pixel data; and loading the first driving voltage or the second driving voltage to the pixel matrix in a data line direction within one frame. The invention avoids crosstalk, bright and dark lines, and improves the display effect.

### FIELD OF THE DISCLOSURE

The present invention relates to the field of pixel matrix display technologies, and in particular to a method for driving a pixel matrix and a display device.

### BACKGROUND OF THE DISCLOSURE

VA type liquid crystal panels are widely used in current display products. At present, VA type panels are mainly divided into two types, one is Multi-domain Vertical Alignment (MVA) type, and the other is Patterned Vertical Alignment (PVA) type. The principle of MVA technology is to add protrusions to form multiple visible areas. The liquid crystal molecules are not completely vertically aligned in the static state, and the liquid crystal molecules are horizontally arranged after the voltage is applied, so that the light can pass through the layers. PVA is a pattern vertical adjustment technology that directly changes the structure of the liquid crystal cell, so that the display performance is greatly improved to obtain brightness output and contrast superior to MVA.

However, in the existing 4-domain VA technology, with the adjustment of the viewing angle, the structure of the VA-type liquid crystal display panel is prone to color washout at a large viewing angle, so that the displayed image is easily distorted, especially the performance of the character's skin color tends to be lighter blue or brighter white. Referring to FIG. 1, as the viewing angle increases (0°, 45°, 60°), the color washout phenomenon becomes more serious. In the 4-domain arrangement, the polarity of the sub-pixels is affected, which causes crosstalk and bright dark lines, and the display effect is poor.

### SUMMARY OF THE DISCLOSURE

In order to solve the above problems in the prior art, embodiments of the present invention provide a method for driving a pixel matrix and a display device that solve a color washout phenomenon and improve a display effect. The technical problem to be solved by the embodiment of the present invention is achieved by the following technical solutions.

Specifically, a method for driving a pixel matrix, the pixel matrix includes a plurality of sub-pixels arranged in a matrix; wherein the method includes receiving an image data, and acquiring original pixel data according to the image data; generating a first driving voltage and a second driving voltage according to the original pixel data; and loading the first driving voltage or the second driving voltage onto the pixel matrix along the data line direction within one frame.

In an embodiment of the invention, the step of generating a first driving voltage and a second driving voltage according to the original pixel data includes obtaining a first gray scale data and a second gray scale data according to the original pixel data; generating the first driving voltage corresponding to the first gray scale data and the second driving voltage corresponding to the second gray scale data according to the first gray scale data and the second gray scale data.

In an embodiment of the invention, the obtaining a first gray scale data and a second gray scale data according to the original pixel data includes: obtaining an original pixel value of each pixel position according to the original pixel data, and converting the original pixel value of each pixel position into the first gray scale data or the second gray scale data according to a predetermined conversion manner.

In an embodiment of the invention, the step of generating a first driving voltage and a second driving voltage according to the original pixel data includes obtaining original data driving signals for respective pixel positions according to the original pixel data; and obtaining the first driving voltage and the second driving voltage according to the original data driving signals.

In an embodiment of the invention, the obtaining the first driving voltage and the second driving voltage according to the original data driving signals includes obtaining an original gray scale value and a conversion rule of a corresponding one of the corresponding pixel positions according to the original data driving signals, and converting the original gray scale value of the corresponding one of the pixel positions into the first driving voltage or the second driving voltage according to the conversion rule.

In an embodiment of the invention, the driving voltages applied to the sub-pixels are polarity reversed once every two sub-pixels in the data line direction, and the driving voltages applied to the sub-pixels are polarity reversed once every sub-pixel in the scanning line direction; and the step of loading the first driving voltage or the second driving voltage onto the pixel matrix along the data line direction within one frame includes: loading the first driving voltage or the second driving voltage to the pixel matrix alternately as per every scanning line, along the data line direction; and loading the first driving voltage or the second driving voltage to the pixel matrix alternately as per every two data lines, along the scanning line direction.

In an embodiment of the invention, the polarity of the data line is column reversed, and each column of sub-pixels alternately connect two adjacent data lines on both sides, the voltages applied to the sub-pixels are polarity reversed once every sub-pixel polarity in the data line direction, and the voltages applied to the sub-pixels are polarity reversed once every sub-pixel polarity in the scanning line direction; and the step of loading the first driving voltage or the second driving voltage onto the pixel matrix along a data line direction within one frame includes: loading the first driving voltage or the second driving voltage to the pixel matrix alternately as per every two scanning lines, along the data line direction; and loading the first driving voltage or the second driving voltage to the pixel matrix alternately as per every two data lines, along the scanning line direction.

In an embodiment of the invention, the polarity of the data line is column reversed, and each column of sub-pixels alternately connect two adjacent data lines on both sides, the voltages applied to the sub-pixels are polarity reversed once every two sub-pixels in the data line direction, and the voltages applied to the sub-pixels are polarity reversed once every sub-pixel polarity in the scanning line direction; and the step of loading the first driving voltage or the second driving voltage onto the pixel matrix along a data line direction within one frame includes: loading the first driving voltage or the second driving voltage to the pixel matrix alternately as per every scanning line, along the data line direction; and loading the first driving voltage or the second driving voltage to the pixel matrix alternately as per every two data lines, along the scanning line direction.

In addition, a display device includes a timing controller, a data driving unit, a scan driving unit, and a display panel. wherein the display panel is provided with a pixel matrix, and the pixel matrix includes a plurality of sub-pixels arranged in a matrix; the timing controller is connected to the data driving unit and the scan driving unit, the data driving unit and the scan driving unit are respectively connected to the pixel matrix; the timing controller is configured to receive an image data, acquire original pixel data according to the image data, acquire a first gray scale data and a second gray scale data according to the original pixel data, and output the first gray scale data and the second gray scale data to the data driving unit; the data driving unit is configured to generate a first driving voltage according to the first gray scale data, and generate a second driving voltage according to the second gray scale data; the scan driving unit is configured to load a scanning signal to the pixel matrix; and in a frame, the data driving unit is further configured to load the first driving voltage corresponding to the first gray scale data or the second driving voltage corresponding to the second gray scale data to the pixel matrix in a data line direction.

In an embodiment of the invention, the timing controller is specifically configured to obtain an original pixel value of each pixel position according to the original pixel data and convert the original pixel value of each pixel position into the first gray scale data or the second gray scale data according to a predetermined conversion manner.

In an embodiment of the invention, the voltages applied to the sub-pixels are polarity reversed once every two sub-pixels in the data line direction, and the voltages applied to the sub-pixels are polarity reversed once every sub-pixel polarity in the scanning line direction.

In an embodiment of the invention, the polarity of the data line is column reversed, and each column of sub-pixels alternately connect two adjacent data lines on both sides, the voltages applied to the sub-pixels are polarity reversed once every sub-pixel polarity in the data line direction, and the voltages applied to the sub-pixels are polarity reversed once every sub-pixel polarity in the scanning line direction.

In an embodiment of the invention, the polarity of the data line is column reversed, and each column of sub-pixels alternately connect two adjacent data lines on both sides, the voltages applied to the sub-pixels are polarity reversed once every two sub-pixels in the data line direction, and the voltages applied to the sub-pixels are polarity reversed once every sub-pixel polarity in the scanning line direction.

In addition, a display device includes a timing controller, a data driving unit, a scan driving unit, and a display panel. Wherein the display panel is provided with a pixel matrix, and the pixel matrix includes a plurality of sub-pixels arranged in a matrix; the timing controller is connected to the data driving unit and the scan driving unit, the data driving unit and the scan driving unit are respectively connected to the pixel matrix; the timing controller is configured to receive an image data, acquire original pixel data according to the image data, and obtain original data driving signals according to the original pixel data; the data driving unit is configured to obtain a first driving voltage and a second driving voltage according to the original data driving signals; the scan driving unit is configured to load a scanning signal to the pixel matrix; and in a frame, the data driving unit is further configured to load the first driving voltage or the second driving voltage onto the pixel matrix in a data line direction.

In an embodiment of the invention, the data driving unit is further configured to obtain an original gray scale value and a conversion rule of a corresponding one of the corresponding pixel positions according to the original data driving signals, and convert the original gray scale value of the corresponding pixel position into the first driving voltage or the second driving voltage according to the conversion rule.

In an embodiment of the invention, the voltages applied to the sub-pixels are polarity reversed once every two sub-pixels in the data line direction, and the voltages applied to the sub-pixels are polarity reversed once every sub-pixel polarity in the scanning line direction.

In an embodiment of the invention, the polarity of the data line is column reversed, and each column of sub-pixels alternately connect two adjacent data lines on both sides, the voltages applied to the sub-pixels are polarity reversed once every sub-pixel polarity in the data line direction, and the voltages applied to the sub-pixels are polarity reversed once every sub-pixel polarity in the scanning line direction.

In an embodiment of the invention, the polarity of the data line is column reversed, and each column of sub-pixels alternately connect two adjacent data lines on both sides, the voltages applied to the sub-pixels are polarity reversed once every two sub-pixels in the data line direction, and the voltages applied to the sub-pixels are polarity reversed once every sub-pixel polarity in the scanning line direction.

Compared with the prior art, the beneficial effects of the embodiments of the present invention are: the method for driving the pixel matrix and the display device of the embodiment of the invention are matched with a low gray scale voltage by a reasonable high gray scale voltage, so that the pixels in the pixel matrix are not affected by the polarity, the problems such as crosstalk, bright and dark lines are avoided, and the display effect is improved.

### BRIEF DESCRIPTION OF THE DRAWINGS

In order to more clearly illustrate the technical solutions of the embodiments of the present application, the drawings used in the description of the embodiments will be briefly described below. Obviously, the drawings in the following description are only some of the embodiments of the present application, and those skilled in the art can obtain other drawings according to the drawings without any creative work.

FIG. 1 is a schematic diagram showing changes in viewing angle with gradation in the related art.

FIG. 2 is a flowchart of a method for driving a pixel matrix according to an embodiment of the present invention.

FIG. 3A is a schematic diagram of polarity loading of a pixel matrix according to a first embodiment of the present invention.

FIG. 3B is a schematic diagram of a gray matrix loading of a pixel matrix according to a first embodiment of the present invention.

FIG. 3C is a schematic diagram of a sub-pixel area according to a third embodiment of the present invention.

FIG. 3D and FIG. 3E are schematic diagrams showing a driving manner in a fourth embodiment of the present invention.

FIG. 4 is a schematic structural diagram of a display device according to an embodiment of the present invention.

FIG. 5A is a schematic diagram of polarity loading of a pixel matrix according to a sixth embodiment of the present invention.

FIG. 5B is a schematic diagram of a gray matrix loading of a pixel matrix according to a sixth embodiment of the present invention.

FIG. 5C is a schematic diagram of a sub-pixel area according to an eighth embodiment of the present invention.

FIG. 5D and FIG. 5E are schematic diagrams showing a driving manner in a ninth embodiment of the present invention.

FIG. 6A is a schematic diagram of polarity loading of a pixel matrix according to an eleventh embodiment of the present invention.

FIG. 6B is a schematic diagram of a gray matrix loading of a pixel matrix according to an eleventh embodiment of the present invention.

FIG. 6C is a schematic diagram of a sub-pixel area according to a thirteenth embodiment of the present invention.

FIG. 6D and FIG. 6E are schematic diagrams showing a driving manner in the fourteenth embodiment of the present invention.

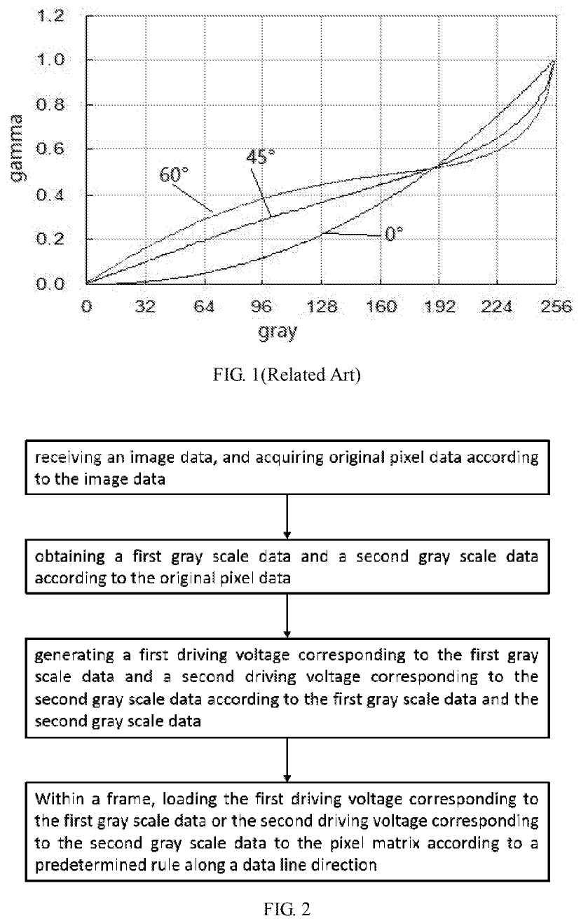

### DETAILED DESCRIPTION OF PREFERRED EMBODIMENTS

The technical solutions in the embodiments of the present application are clearly and completely described in the following with reference to the drawings in the embodiments of the present application. It is obvious that the described embodiments are only a part of the embodiments of the present application, and not all of the embodiments. All other embodiments obtained by a person of ordinary skill in the art based on the embodiments of the present application without departing from the inventive scope are the scope of the present application.

### Embodiment 1

Referring to FIG. 2, FIG. 2 is a flowchart of a method for driving a pixel matrix according to an embodiment of the present invention. The pixel matrix includes a plurality of sub-pixels arranged in a matrix, the voltages applied to the sub-pixels are polarity reversed once every two sub-pixels in the data line direction, and the voltages applied to the sub-pixels are polarity reversed once every sub-pixel polarity in the scanning line direction; the driving method includes:

receiving an image data, and acquiring original pixel data according to the image data;

obtaining a first gray scale data and a second gray scale data according to the original pixel data;

generating the first driving voltage corresponding to the first gray scale data and the second driving voltage corresponding to the second gray scale data according to the first gray scale data and the second gray scale data; and

loading the first driving voltage corresponding to the first gray scale data or the second driving voltage corresponding to the second gray scale data to the pixel matrix in the data line direction in one frame.

The image data refers to a digital signal input to the timing controller TCON, and the image data is input frame by frame, and the original pixel data is parsed by the image data. In an existing technical solution, the original pixel data, that is, a specific pixel value corresponding to each sub-pixel in the pixel matrix, is displayed in each frame. The pixel value input to each sub-pixel is directly determined by the image data input into the TCON, and the original pixel data is not processed. Such methods are affected by the polarity of the sub-pixels, resulting in sub-pixel polarities that are prone to crosstalk, and dark and dark lines.

In this embodiment, by processing the original pixel data, further first gray scale data and second gray scale data are obtained, and the gray scales of the first gray scale data and the second gray scale data are different. Furthermore, the image is loaded into the corresponding sub-pixels at different intervals between different pixels or between different frames. The solution in this embodiment can generate two sets of different gray scales, respectively corresponding to different sub-pixels. In this way, it is possible to prevent the voltage applied to the sub-pixel from being affected by the polarity reversed, thereby avoiding the occurrence of crosstalk and bright and dark lines.

In a specific example, the first gray scale data is considered to be high gray scale data, and the second gray scale data is considered to be low gray scale data. Correspondingly, the magnitude of the voltage input to the sub-pixel is determined by the gray scale. Generating the high gray scale voltage corresponding to the high gray scale data, that is, the first driving voltage, and the low gray scale voltage corresponding to the low gray scale data, that is, the second driving voltage. It is worth mentioning that the above-mentioned high gray scale and low gray scale represent the relative values of the gray scale sizes of the two groups, and the magnitude of the values is not separately limited.

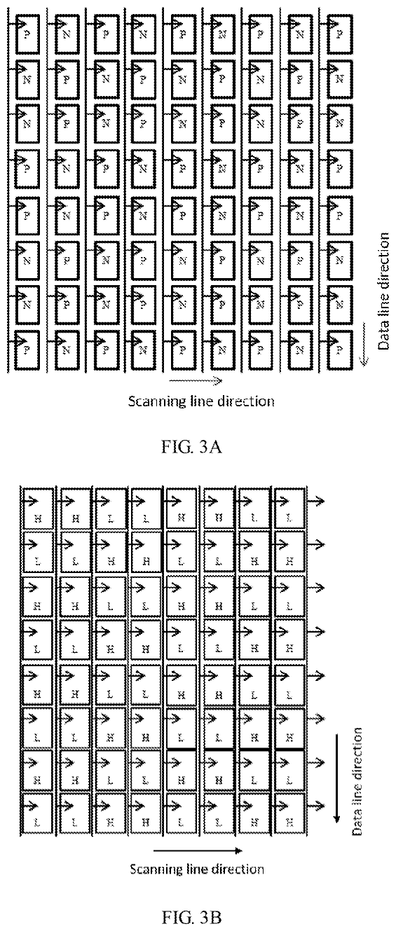

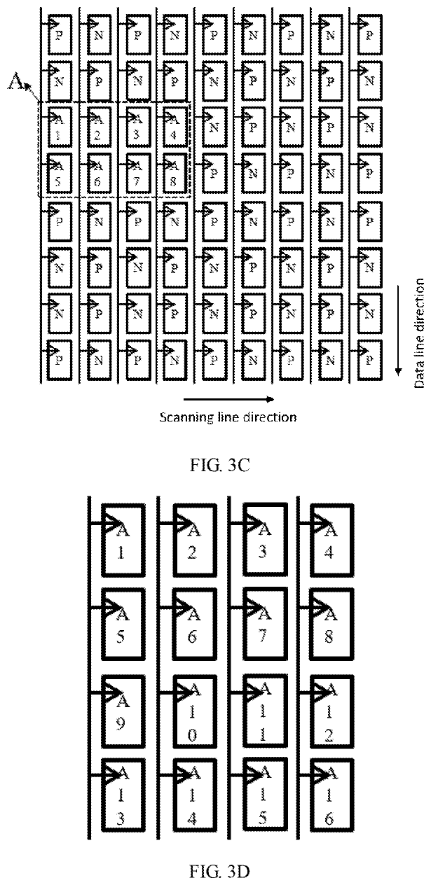

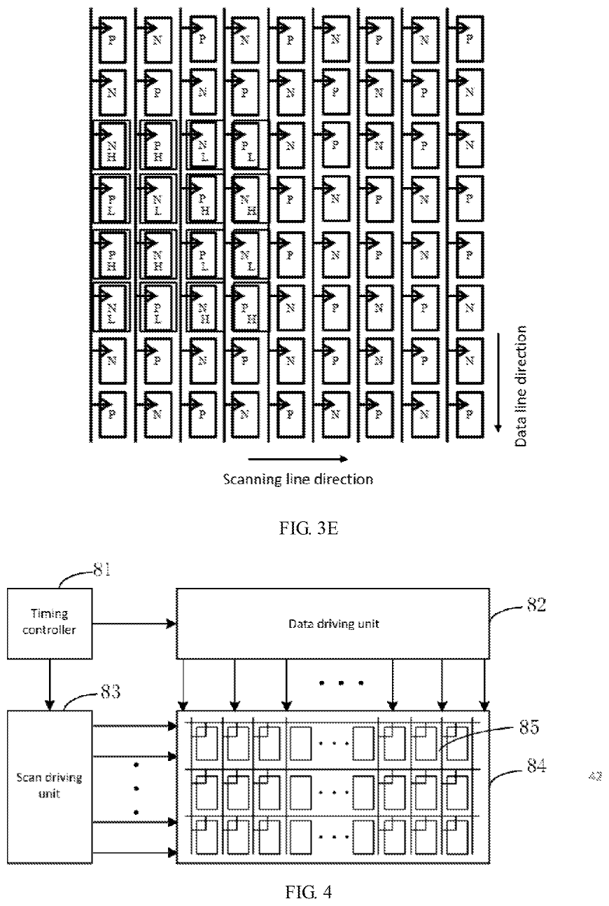

Referring to FIG. 3A, from one column, two consecutive sub-pixels have the same polarity, and the next two consecutive sub-pixels have opposite polarities from the upper two polarities. From a certain line, the sub-pixel polarity is alternately reversed, and so on. Overall, the voltages applied to the sub-pixels are polarity reversed once every two sub-pixels in the data line direction, and the voltages applied to the sub-pixels are polarity reversed once every sub-pixel polarity in the scanning line direction. In FIG. 3A, P represents a positive voltage and N represents a negative voltage. From a certain column, the polarity transformation can be expressed as NNPP . . . NNPP or PPNN . . . PPNN. From a certain line, the polarity transformation can be expressed as PNPN . . . PNPN or NPNP . . . NPNP.

In a specific embodiment, obtaining the first gray scale data and the second gray scale data according to the original pixel data, including: obtaining an original pixel value of each pixel position according to the original pixel data; converting original pixel value of each pixel position into first gray scale data or second gray scale data according to a predetermined conversion manner.

After determining the gray scale corresponding to each pixel position according to the rule of the present invention, the timing controller adjusts the original gray scale correspondence of the pixel position to a high gray scale or a low gray scale, and a data driving unit that loads the adjusted gray scale value, and the number driving unit outputs a corresponding voltage according to the gray scale value.

For example, the original pixel value of the A position is 128 gray scale, and according to the above rule of the present invention, the A position should output a high gray scale, that is, H, after calculation, in this example, 128 gray scale corresponding H=138 gray scale value, then output 138 gray scale to the A position, the data driving unit receives 138 gray scale, according to the established conversion rules, the voltage corresponding to the 138 gray scale is 10V, and finally the voltage signal of 10V is output to the A position. Generally, the adjustment range of the high and low gray scales is determined by the difference of materials such as liquid crystal.

For another example, the original pixel value of the B position is 128 gray scale. According to the above rule of the present invention, the B position should output a low gray scale, that is, L, after calculation, in this example, the 128 gray scale corresponds to the L=118 gray scale value, then the output is 118 gray scale to the B position, and the data driving unit receives the 118 gray scale, according to the established conversion rules, the voltage corresponding to the gray scale of 118 is 8V, and finally the voltage signal of 8V is output to the B position.

In a specific embodiment, and the step of loading the first driving voltage corresponding to the first gray scale data or the second driving voltage corresponding to the second gray scale data in the data line direction to the pixel matrix includes:

loading the first driving voltage or the second driving voltage to the pixel matrix alternately as per every other scanning line, along the data line direction; and

loading the first driving voltage or the second driving voltage to the pixel matrix alternately as per every two data lines, along the scanning line direction;

The pixel matrix is physically divided into a plurality of small blocks arranged in a matrix by a plurality of interleaved data lines and scanning lines, and each small block is a sub-pixel. Each two adjacent sub-pixels are divided by a corresponding one of the data lines or the scanning lines. In the data line direction, every other scanning line alternately loads the first driving voltage or the second driving voltage to the pixel matrix representation: as far as a column is concerned, different driving voltages are loaded between adjacent sub-pixels; or, in terms of a certain row, a different driving voltage is loaded between each adjacent two sub-pixels; alternately applied to the sub-pixels in accordance with the above relationship.

Referring to FIG. 3B, reference may be made to the following example. From a certain row, the gray scale voltages of two consecutive sub-pixels are the same, and the gray scale voltages of two consecutive sub-pixels loaded are different from the previous two. From a certain column, the gray scale voltages loaded into the sub-pixels are alternately transformed, and so on. In FIG. 3B, H represents a high gray scale voltage, and L represents a low gray scale voltage. From a certain column, the gray scale voltage conversion can be expressed as HLHL . . . HLHL or LHLH . . . LHLH, from a certain line, the gray scale voltage transformation can be expressed as HHLL . . . HHLL or LLHH . . . LLHH.

The method for driving the pixel matrix of the invention is matched with the low gray scale voltage by a reasonable high gray scale voltage, so that the pixels in the pixel matrix are not affected by the polarity, and the problems such as crosstalk, bright and dark lines are avoided, and the display effect is improved.

### Embodiment 2

Another embodiment of the present invention provides another method for driving the pixel matrix, where the pixel matrix includes a plurality of sub-pixels arranged in a matrix, the voltages applied to the sub-pixels are polarity reversed once every two sub-pixels in the data line direction, and the voltages applied to the sub-pixels are polarity reversed once every sub-pixel polarity in the scanning line direction. The driving method includes:

receiving an image data, and acquiring original pixel data according to the image data;

obtaining original data driving signals for respective pixel positions according to the original pixel data;

obtaining a first driving voltage and a second driving voltage according to the original data driving signals; and

loading the first driving voltage or the second driving voltage onto the pixel matrix along the data line direction within one frame.

Further, loading the first driving voltage or the second driving voltage onto the pixel matrix along the data line direction within one frame, including:

loading the first driving voltage or the second driving voltage to the pixel matrix every other scanning line, along the data line direction; and

loading the first driving voltage or the second driving voltage onto the pixel matrix every two data lines, along the scanning line direction.

According to the above, in the driving method, the original pixel data of the embodiment corresponds to a set of gray scale values, in the data driving circuit, generating original data driving signals corresponding to the gray scale value, and adjusting the original data driving signals to two different driving voltages, that is, the first driving voltage or the second driving voltage is correspondingly outputted. In this embodiment, by using two sets of different gammas to generate driving signals for driving the sub-pixels, a set of original data driving signals are generated under different gamma to generate two sets of driving voltages, and then the driving control of the embodiment is implemented. In a specific embodiment manner of the solution of the embodiment, the TCON outputs a set of gray scales, and the data driving circuit generates two sets of gammas, and each group respectively drives different sub-pixels, thereby achieving the same technical effect as that of the first embodiment.

In a specific embodiment, obtaining the first driving voltage and the second driving voltage according to the original data driving signals, including: obtaining an original gray scale value and a conversion rule of a corresponding one of the corresponding pixel positions according to the original data driving signals, and converting the original gray scale value of the corresponding one of the pixel positions into the first driving voltage or the second driving voltage according to the conversion rule.

The timing controller of the embodiment analyzes the original image, analyzes the original gray scale value of each pixel position, and determines a conversion rule corresponding to the position, the conversion rule adjusts the original gray scale value to a high gray scale H or a low gray scale L. The driving method of this embodiment does not directly perform gray scale conversion in the timing controller. It sends the original gray scale value and the corresponding H or L conversion rule to the data driving unit, and the data driving unit directly outputs the corresponding driving voltage according to the original gray scale value and the corresponding H or L according to the rule. Generally, the adjustment range of the high and low gray scales is determined by the difference of materials such as liquid crystal.

For example, in one embodiment, the original pixel value of the A position is 128 gray scale, and 128 gray scale is output for the A position, and the position A should be H according to the conversion rule. After receiving the 128 gray scale, the driver circuit finds the corresponding voltage 10V in the gray scale corresponding voltage conversion table of H, and finally outputs a driving voltage signal of 10V to the A position.

For example, if the original pixel value of the B position is 128 gray scale, then 128 gray scale is output for the B position. According to the conversion rule, the B position should be after the L driving circuit receives 128 gray scales, find the corresponding voltage 8V in the gray scale corresponding pressure conversion table of L, and finally output 8V data signal to the A position.

### Embodiment 3

In a specific embodiment, in order to more clearly demonstrate the solution of the present invention, the pixel matrix includes a plurality of sub-pixel areas, and each of the sub-pixel areas includes:

a first sub-pixel;

a second sub-pixel adjacent to the first sub-pixel along a scanning line direction;

a third sub-pixel adjacent to the second sub-pixel along a scanning line direction;

a fourth sub-pixel adjacent to the third sub-pixel along a scanning line direction;

a fifth sub-pixel adjacent to the first sub-pixel along a data line direction;

a sixth sub-pixel adjacent to the second sub-pixel along a data line direction;

a seventh sub-pixel adjacent to the third sub-pixel along a data line direction;

an eighth sub-pixel adjacent to the fourth sub-pixel along a data line direction;

a first data line electrically connecting the first sub-pixel and the fifth sub-pixel;

a second data line electrically connecting the second sub-pixel and the sixth sub-pixel;

a third data line electrically connecting the third sub-pixel and the seventh sub-pixel; and

a fourth data line electrically connecting the fourth sub-pixel and the eighth sub-pixel.

Referring to FIG. 3C, the area indicated by the mark A is represented as a sub-pixel area, and each sub-pixel area includes eight sub-pixels, which are divided into upper and lower lines, four sub-pixels in each line. The first pixel A1, the second pixel A2, the third pixel A3, and the fourth pixel A4 are in a row, and the fifth pixel A5, the sixth pixel A6, the seventh pixel A7, and the eighth pixel A8 are in the next row facing the uplink. The pixel matrix is sequentially filled by a plurality of sub-pixel areas. The first data line is connected to the first pixel A1 and the fifth pixel A5, the second data line is connected to the second pixel A2 and the sixth pixel A6, the third data line is connected to the third pixel A3 and the seventh pixel A7, and the fourth data line is connected to the fourth pixel A4 and the eighth pixel A8.

In a specific embodiment, the voltages applied to the first pixel A1, the third pixel A3, the sixth pixel A6, and the eighth pixel A8 have the same polarity, and the voltages applied to the second pixel A2, the fourth pixel A4, the fifth pixel A5, and the seventh pixel A7 are opposite in polarity.

The voltage gray scales loaded onto the first pixel A1, the second pixel A2, the seventh pixel A7 and the eighth pixel A8 are different from the voltage gray scales loaded onto the third pixel A3, the fourth pixel A4, the fifth pixel A5, and the sixth pixel A6.

According to the above-mentioned cooperation relationship between the polarity of the voltage applied to the sub-pixel and the gray scale of the voltage, a specific embodiment is shown. Within one frame, loading a negative polarity high gray scale voltage to the first pixel A1, which can be represented as HN; loading a positive polarity high gray scale voltage to the second pixel A2, which can be expressed as HP; loading a negative polarity low gray scale voltage to the third pixel A3, which can be represented as LN; and loading a positive polarity low gray scale voltage to the fourth pixel A4, which can be expressed as LP; loading a positive low-gradation voltage to the fifth pixel A5, which can be expressed as LP; and loading a negative low-gradation voltage to the sixth pixel A6, which can be expressed as LN; loading a positive polarity high gray scale voltage to the seventh pixel A7, which may be represented as HP; loading the eighth pixel A8 with a negative polarity high gray scale voltage, which may be represented as HN.

In order to more clearly describe the above voltage loading relationship, from a certain column, the voltage relationship loaded for each sub-pixel in any column is expressed as follows: HN, LP, HP, LN, HN, LP, HP, LN . . . sequentially cycled or HP, LN, HN, LP, HP, LN, HN, LP . . . sequentially cycled; from a certain line, the voltage relationship loaded for each sub-pixel in any row is sequentially expressed as: HN, HP, LN, LP, HN, HP, LN, LP . . . sequentially cycled or LP, LN, HP, HN, LP, LN, HP, HN . . . sequentially cycled.

Alternatively, loading a positive polarity high gray scale voltage to the first pixel A1, which may be represented as HP; loading a negative polarity high gray scale voltage to the second pixel A2, which may be represented as HN; loading a positive low-gradation voltage to the third pixel A3, which can be represented as LP; loading a negative low-gradation voltage to the fourth pixel A4, which can be expressed as LN; loading a negative polarity low gray scale voltage to the fifth pixel A5, which can be represented as LN; and loading the sixth pixel A6 with a positive low gray scale voltage, which can be expressed as LP; loading a negative polarity high gray scale voltage to the seventh pixel A7, which can be represented as HN; loading a positive polarity high gray scale voltage to the eighth pixel A8, which can be expressed as HP.

In order to more clearly describe the above voltage loading relationship, from a certain column, the voltage relationship loaded for each sub-pixel in any column is expressed as follows: HP, LN, HP, LN, HN, LP, HP, LN . . . sequentially cycled or HN, LP, HP, LN, HN, LP, HP, LN . . . sequentially cycled; from a certain line, the voltage relationship loaded for each sub-pixel in any row is sequentially expressed as: HP, HN, LP, LN, HP, HN, LP, LN . . . sequentially cycled or LN, LP, HN, HP, LN, LP, HN, HP . . . sequentially cycled.

In another embodiment, the voltages applied to the first pixel A1, the third pixel A3, the fifth pixel A5, and the seventh pixel A7 are the same polarity, and the voltages applied to the second pixel A2, the fourth pixel A4, the sixth pixel A6, and the eighth pixel A8 are opposite in polarity. And the voltage gray scales loaded onto the first pixel A1, the second pixel A2, the seventh pixel A7 and the eighth pixel A8 are different from the voltage gray scales loaded onto the third pixel A3, the fourth pixel A4, the fifth pixel A5, and the sixth pixel A6. This driving method can regain the gray scale voltage relationship loaded on the pixel according to the above example, and will not be described again.

### Embodiment 4

Please refer to FIG. 3D and FIG. 3E, in an optional 4×4 area, in the first column, the first pixel A1, the fifth pixel A5, the ninth pixel A9, and the thirteenth pixel A13 are connected to the first data line, in the second column, the second pixel A2, the sixth pixel A6, the tenth pixel A10, and the fourteenth pixel A14 are connected to the second data line, in the third column, the third pixel A3, the seventh pixel A7, the eleventh pixel A11, and the fifteenth pixel A15 are connected to the third data line, in the fourth column, the fourth pixel A4, the eighth pixel A8, the twelfth pixel A12, and the sixteenth pixel A16 are connected to the fourth data line.

At a first moment in a frame, loading a scanning signal on the first row of the scanning line, loading the voltage corresponding to the HN to the first pixel A1 on the first data line, loading the voltage corresponding to the HP to the second pixel A2 on the second data line, loading the voltage corresponding to the LN to the third pixel A3 on the third data line, loading the voltage corresponding to the LP to the fourth pixel A4 on the fourth data line, and so on;

at the next moment (the second moment), loading the scanning signal to the second row of scanning lines, loading the voltage corresponding to the LP to the fifth pixel A5 on the first data line, loading the voltage corresponding to the LN to the sixth pixel A6 on the second data line, loading the voltage corresponding to the HP to the seventh pixel A7 on the third data line, loading the voltage corresponding to the HN to the eighth pixel A8 on the fourth data line;

at the next moment (the third moment), loading the scanning signal to the third row of scanning lines, loading the voltage corresponding to the HP to the ninth pixel A9 on the first data line, loading the voltage corresponding to the HN to the tenth pixel A10 on the second data line, loading the voltage corresponding to the LP to the eleventh pixel A11 on the third data line, loading the voltage corresponding to the LN to the twelfth pixel A12 on the fourth data line;

at the next moment (the fourth moment), loading the scanning signal to the fourth row of scanning lines, loading the voltage corresponding to the LN to the thirteenth pixel A13 on the first data line, loading the voltage corresponding to the LP to the fourteenth pixel A14 on the second data line, loading the voltage corresponding to the HN to the fifteenth pixel A15 on the third data line, loading the voltage corresponding to the HP to the sixteenth pixel A16 on the fourth data line. This scheme lists the voltage loading in the case of 4×4, and the other sub-pixels and other times are sequentially loaded with the corresponding voltages according to the above rules.

With the above embodiment of the present invention, by alternately loading positive and negative voltages and high and low gray scale voltages to the pixel matrix, the side visibility can be improved, and the pixels in the pixel matrix are not affected by the polarity, which improves crosstalk, bright and dark lines, and the like, and improves the display effect.

### Embodiment 5

Referring to FIG. 4, an embodiment of the present invention provides a display device suitable for performing the method for driving the pixel matrix of the foregoing first embodiment, the third embodiment, and the fourth embodiment of the present invention, including a timing controller 81, a data driving unit 82, a scan driving unit 83 and a display panel 84. The display panel 84 is provided with a pixel matrix 85; the timing controller 81 is connected to the data driving unit 82 and the scan driving unit 83, the data driving unit 82 and the scan driving unit 83 are connected to the pixel matrix 85;

the timing controller 81 is configured to output first gray scale data and second gray scale data to the data driving unit 82;

the data driving unit 82 is configured to generate a first driving voltage according to the first gray scale data, and generate a second driving voltage according to the second gray scale data;

the scan driving unit 83 is configured to load a scanning signal to the pixel matrix 85;

and within a frame, the data driving unit 82 is further configured to load the first driving voltage corresponding to the first gray scale data or the second driving voltage corresponding to the second gray scale data to the pixel matrix 85 in the data line direction.

In a specific embodiment, the timing controller is specifically configured to obtain an original pixel value of each pixel position according to the original pixel data. The original pixel value of each pixel position is converted into first gray scale data or second gray scale data in accordance with a predetermined conversion manner.

The display panel 84 includes a plurality of data lines, a plurality of scanning lines, and a plurality of sub-pixels connected to the data lines and the scanning lines. The sub-pixels are arranged on the display panel in the data line direction and in the scanning line direction to form a pixel matrix 85, and the timing controller 81 accesses the RGB data signals of the image from the outside, the timing controller 81 can access red image data R, green image data G blue image data B, or image data of other colors from the outside, and generate corresponding original pixel data according to the image data, and corresponding the original pixel data to two sets of gray scale, high gray scale data and low gray scale data according to the above rules of the present invention. The data driving circuit converts the high gray scale data and the low gray scale data into a corresponding high gray scale voltage and a low gray scale voltage by using a fixed gamma. The data driving unit 82 controls a specific output operation according to the above method of the present invention, and outputs an output of high gray scale, low gray scale, positive voltage, and negative voltage in accordance with timing correspondence.

In another embodiment, the display device is adapted to perform the method for driving the pixel matrix of the foregoing second embodiment, the third embodiment, and the fourth embodiment of the present invention, and includes, for example, a timing controller 81, a data driving unit 82, a scan driving unit 83 and a display panel 84, the display panel 84 is provided with a pixel matrix 85; the timing controller 81 is connected to the data driving unit 82 and the scan driving unit 83, the data driving unit 82 and the scan driving unit 83 are connected to the pixel matrix 85;

the timing controller 81 is configured to obtain original data driving signals according to the original pixel data;

the data driving unit 82 is configured to obtain a first driving voltage and a second driving voltage according to the original data driving signals;

the scan driving unit 83 is configured to load a scanning signal to the pixel matrix 85;

and the data driving unit 82 is further configured to load the first driving voltage or the second driving voltage onto the pixel matrix 85 in a data line direction within one frame.

The data driving unit is further configured to obtain an original gray scale value and a conversion rule of a corresponding one of the corresponding pixel positions according to the original data driving signals, and convert the original gray scale value of the corresponding pixel position into the first driving voltage or the second driving voltage according to the conversion rule.

The timing controller 81 accesses image data from the outside, generates corresponding original pixel data according to the image data, and outputs the original data driving signals to the data driving circuit. Since the data driving circuit only receives the original gray scale value and the corresponding H or L conversion rule, the data driving circuit generates a high gamma high gray scale voltage and a low gamma low gray scale voltage through two different gamma correspondences. The data driving unit 82 controls a specific output operation according to the above method of the present invention, and outputs an output of high gray scale, low gray scale, positive voltage, and negative voltage in accordance with timing correspondence.

### Embodiment 6

Referring to FIG. 2, in a method for driving a pixel matrix provided by an embodiment of the present invention, the pixel matrix includes a plurality of sub-pixels arranged in a matrix, and the polarity of the data lines are exchanged once for each column in the scanning line direction. The voltages applied to the sub-pixels are polarity reversed once every sub-pixel polarity in the data line direction, and the voltages applied to the sub-pixels are polarity reversed once every sub-pixel polarity in the scanning line direction; wherein the method includes:

receiving an image data, and acquiring original pixel data according to the image data;

obtaining a first gray scale data and a second gray scale data according to the original pixel data;

generating the first driving voltage corresponding to the first gray scale data and the second driving voltage corresponding to the second gray scale data according to the first gray scale data and the second gray scale data; and

loading the first driving voltage or the second driving voltage onto the pixel matrix along the data line direction within one frame.

The image data refers to a digital signal input to the timing controller TCON, the image data is input frame by frame, and the original pixel data is parsed by the image data. In an existing technical solution, the original pixel data, that is, the specific pixel value corresponding to each sub-pixel in each pixel of the pixel matrix, the pixel value input to each sub-pixel is directly determined by the image data input into the TCON, and the original pixel data is not processed. Such methods are affected by the polarity of the sub-pixels, which causes the sub-pixel polarity to be prone to crosstalk, bright and dark lines and other negative effects.

In this embodiment, by processing the original pixel data, further first gray scale data and second gray scale data are obtained, the gray scales of the first gray scale data and the second gray scale data are different, and then loaded into corresponding sub-pixels at different arrangement intervals between different pixels or between different frames. The solution of this embodiment can generate two sets of different gray scales, corresponding to different sub-pixels, respectively. In this way, it is possible to prevent the voltage applied to the sub-pixel from being affected by the polarity reversed, thereby avoiding the occurrence of crosstalk and bright and dark lines.

In a specific example, the first gray scale data is considered to be high gray scale data, and the second gray scale data is considered to be low gray scale data, corresponding, the magnitude of the voltage input to the sub-pixel is determined by the gray scale, and the high gray scale voltage corresponding to the high gray scale data is generated, that is, the first driving voltage; and the low gray scale voltage corresponding to the low gray scale data, that is, the second driving voltage. It is worth mentioning that the above-mentioned high gray scale and low gray scale represent the relative values of the gray scale sizes of the two groups, and the magnitude of the values is not separately limited.

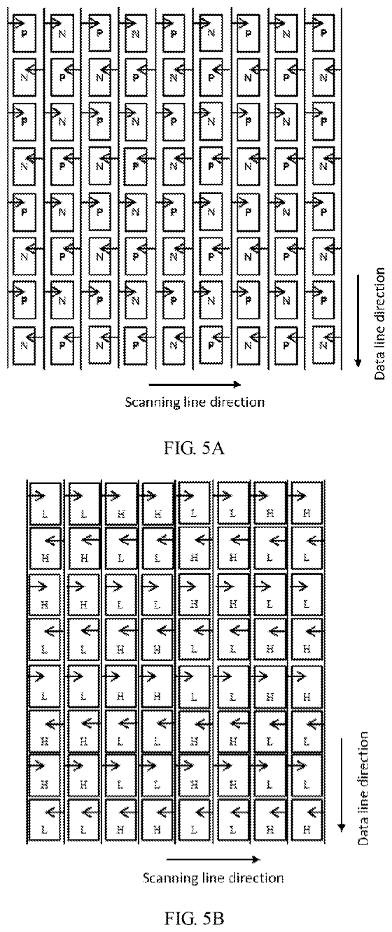

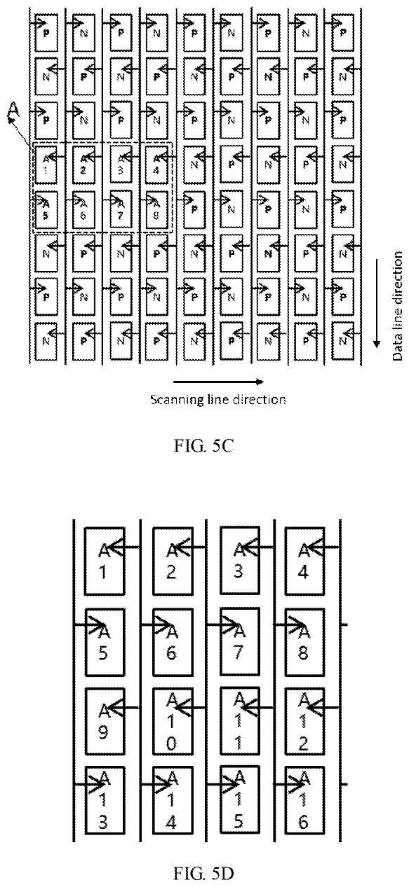

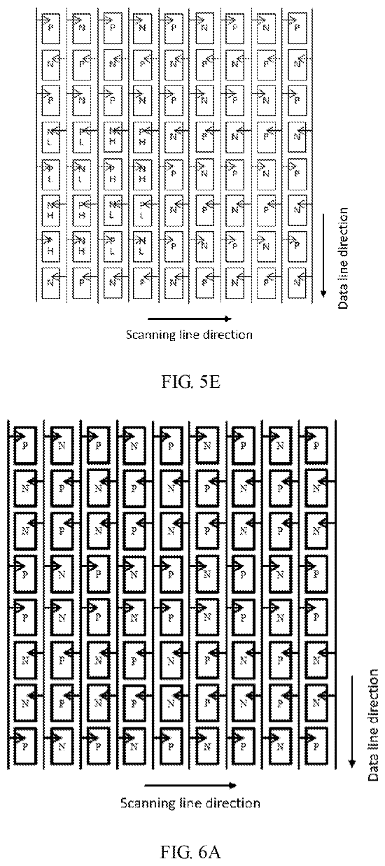

See FIG. 5A, the polarity of the data line is exchanged once in each column along the scanning line direction, and the polarity of the data line is a column reversed mode, and each column is exchanged once in the scanning line direction. By using the data line flipping arrangement, the sub-pixel polarity is exchanged once for one sub-pixel along the data line direction, and the sub-pixel polarity is exchanged once for one sub-pixel along the scanning line direction. From a certain column, the sub-pixel polarity is alternately reversed. From a certain line, the sub-pixel polarity is alternately reversed, and so on. In general, the voltage applied to the sub-pixels is inverted once every sub-pixel polarity in the data line direction, and the voltage applied to the sub-pixels is inverted once every sub-pixel polarity in the scanning line direction. In FIG. 3, P represents a positive voltage and N represents a negative voltage. From a column, the sub-pixel polarity transformation can be expressed as NPNP . . . NPNP or PNPN . . . PNPN, from a certain line, the polarity transformation can be expressed as NPNP . . . NPNP or PNPN . . . PNPN.

In a specific embodiment, obtaining the first gray scale data and the second gray scale data according to the original pixel data, including: obtaining an original pixel value of each pixel position according to the original pixel data, converting the original pixel value of each pixel position into first gray scale data or second gray scale data according to a predetermined conversion manner.

After determining the gray scale corresponding to each pixel position according to the rule of the present invention, the timing controller adjusts the original gray scale correspondence of the pixel position to a high gray scale or a low gray scale, and the adjusted gray scale value is sent to the data driving unit, and the digital driving unit outputs the corresponding voltage according to the gray scale value.

For example, the original pixel value of the A position is 128 gray scale, and according to the above rule of the present invention, the A position should output a high gray scale, that is, H, after calculation, in this example, 128 gray scale corresponding H=138 gray scale value, then output 138 gray scale to the A position, the data driving unit receives 138 gray scale, according to the established conversion rule, the voltage corresponding to 138 gray scale is 10V, and finally the voltage signal of 10V is output to the A position. Generally, the adjustment range of the high and low gray scales is determined by the difference of materials such as liquid crystal.

For another example, the original pixel value of the B position is 128 gray scale. According to the above rule of the present invention, the B position should output a low gray scale, that is, L. after calculation, in this example, the 128 gray scale corresponds to the L=118 gray scale value, then the output is 118 gray scale to the B position, and the data driving unit receives the 118 gray scale, according to the established conversion rules, the voltage corresponding to the gray scale of 118 is 8V, and finally the voltage signal of 8V is output to the B position.

In a specific embodiment, the step of loading of the first driving voltage corresponding to the first gray scale data or the second driving voltage corresponding to the second gray scale data in the data line direction according to a predetermined rule to the pixel matrix includes:

loading the first driving voltage and the second driving voltage to the pixel matrix alternately as per every two scanning lines along a data line direction; and

loading the first driving voltage and the second driving voltage onto the pixel matrix alternately as per every two data lines along a scanning line direction.

The pixel matrix is physically divided into a plurality of small blocks arranged in a matrix by a plurality of interleaved data lines and scanning lines, each small block is a sub-pixel, and adjacent sub-pixels are divided by a corresponding one of the data lines or the scanning lines. Referring to FIG. 5B, reference may be made to the following example. From a certain row, the gray scale voltages of two consecutive sub-pixels are the same, and the gray scale voltages of two consecutive sub-pixels loaded are different from the previous two, from a certain column, the gray scale voltages of two consecutive sub-pixels are the same, and the gray scale voltages of two consecutive sub-pixels loaded are different from the previous two, and so on. In FIG. 5B, H represents a high gray scale voltage, and L represents a low gray scale voltage, from a certain line, the gray scale voltage transformation can be expressed as HHLL . . . HHLL or LLHH . . . LLHH, from a certain column, the gray scale voltage transformation can be expressed as HHLL . . . HHLL or LLHH . . . LLHH.

The method for driving the pixel matrix of the embodiment is matched with the low gray scale voltage by a reasonable high gray scale voltage, so that the pixels in the pixel matrix are not affected by the polarity, and the problems such as crosstalk, bright and dark lines are avoided, and the display effect is improved.

### Embodiment 7

The embodiment of the invention simultaneously provides another method for a driving pixel matrix. The pixel matrix includes a plurality of sub-pixels arranged in a matrix, and the polarity of the data lines are exchanged once for each column in the scanning line direction. The voltage applied to the sub-pixel is inverted once every sub-pixel polarity in the data line direction, and the voltage applied to the sub-pixel is inverted once every sub-pixel polarity in the scanning line direction; wherein the method includes:

receiving an image data, and acquiring original pixel data according to the image data;

obtaining original data driving signals for respective pixel positions according to the original pixel data;

obtaining a first driving voltage and a second driving voltage according to the original data driving signals; and

loading the first driving voltage or the second driving voltage onto the pixel matrix along a data line direction within one frame.

In a specific embodiment, obtaining the first driving voltage and the second driving voltage according to the original data driving signals, including: obtaining an original gray scale value and a conversion rule of a corresponding one of the corresponding pixel positions according to the original data driving signals, and converting the original gray scale value of the corresponding one of the pixel positions into the first driving voltage or the second driving voltage according to the conversion rule.

The timing controller of the present invention analyzes the original image, analyzes the original gray scale value of each pixel position, and determines a conversion rule corresponding to the position, and the conversion rule adjusts the original gray scale value to a high gray scale H or a low gray scale L. The method of the present invention does not directly perform gray scale conversion in the timing controller and sends the original gray scale value and the corresponding H or L conversion rule to the data driving unit. The data driving unit directly outputs the corresponding driving voltage according to the original gray scale value and the corresponding H or L according to the rule.

For example, in one embodiment, the original pixel value of the A position is 128 gray scale, and 128 gray scale is output for the A position, and the position A should be H according to the conversion rule. After receiving the 128 gray scale, the driver circuit finds the corresponding voltage 10V in the gray scale corresponding voltage conversion table of H, and finally outputs a driving voltage signal of 10V to the A position.

For example, if the original pixel value of the B position is 128 gray scale, then 128 gray scale is output to the B position. According to the conversion rule, the B position should be after the L drive circuit receives 128 gray scales, find the corresponding voltage 8V in the gray scale corresponding pressure conversion table of L, and finally output 8V data signal to the A position.

In a specific embodiment, loading the first driving voltage or the second driving voltage to the pixel matrix every other scanning line, along the data line direction; and loading the first driving voltage or the second driving voltage to the pixel matrix every two data lines, along the scanning line direction.

In the method, the original pixel data of the embodiment corresponds to a set of gray scale values. In the data driving circuit, the original data driving signals corresponding to the gray scale value is generated, and the original data driving signals is adjusted to two different driving voltages, that is, the first driving voltage or the second driving voltage is output correspondingly. In this embodiment, by using two sets of different gammas to generate driving signals for driving sub-pixels, a set of original data driving signals are generated under different gamma to generate two sets of driving voltages, and then the driving control of the present invention is implemented. In a specific embodiment of the solution of the embodiment, the TCON outputs a set of gray scales, and the data driving circuit generates two sets of gammas, and each group respectively drives different sub-pixels, thereby achieving the same technical effect as the first embodiment.

The method for driving the pixel matrix of the embodiment is matched with the low gray scale voltage by a reasonable high gray scale voltage, so that the pixels in the pixel matrix are not affected by the polarity, and the problems such as crosstalk, bright and dark lines are avoided, and the display effect is improved.

### Embodiment 8

In a specific embodiment, in order to more clearly demonstrate the solution of the present invention, the pixel matrix includes a plurality of sub-pixel areas, and each of the sub-pixel areas includes:

a first sub-pixel;

a second sub-pixel adjacent to the first sub-pixel along a scanning line direction;

a third sub-pixel adjacent to the second sub-pixel along a scanning line direction;

a fourth sub-pixel adjacent to the third sub-pixel along a scanning line direction;

a fifth sub-pixel adjacent to the first sub-pixel along a data line direction;

a sixth sub-pixel adjacent to the second sub-pixel along a data line direction;

a seventh sub-pixel adjacent to the third sub-pixel along a data line direction;

an eighth sub-pixel adjacent to the fourth sub-pixel along a data line direction;

a first data line electrically connecting the fifth sub-pixel;

a second data line electrically connecting the first sub-pixel and the sixth sub-pixel;

a third data line electrically connecting the second sub-pixel and the seventh sub-pixel;

a fourth data line electrically connecting the third sub-pixel and the eighth sub-pixel; and

a fifth data line electrically connecting the fourth sub-pixel.

See FIG. 5C, the area indicated by the mark A is represented as a sub-pixel area, and each sub-pixel area includes eight sub-pixels, which are divided into upper and lower lines, four sub-pixels in each line. The first pixel A1, the second pixel A2, the third pixel A3, and the fourth pixel A4 are in a row, and the fifth pixel A5, the sixth pixel A6, the seventh pixel A7, and the eighth pixel A8 are in the next row facing the uplink. The pixel matrix is sequentially filled by a plurality of sub-pixel areas. The first data line is connected to the fifth pixel A5, and the second data line is connected to the first pixel A1 and the sixth pixel A6. The third data line is connected to the second pixel A2, the seventh pixel A7, the fourth data line is connected to the third pixel A3, the eighth pixel A8, and the fifth data line is connected to the fourth pixel A4.

In a specific embodiment, the voltages applied to the first pixel A1, the third pixel A3, the sixth pixel A6 and the eighth pixel A8 have the same polarity and are opposite in polarity to the voltages applied to the second pixel A2, the fourth pixel A4, the fifth pixel A5 and the seventh pixel A7.

The voltage gray scales loaded onto the first pixel A1, the second pixel A2, the seventh pixel A7 and the eighth pixel A8 are different from the voltage gray scales loaded onto the third pixel A3, the fourth pixel A4, the fifth pixel A5 and the sixth pixel A6.

According to the above-mentioned cooperation relationship between the polarity of the voltage applied to the sub-pixel and the gray scale of the voltage, a specific embodiment is shown. Within one frame, loading a negative low gray scale voltage to the first pixel A1, which may be represented as LN; loading a second positive polarity gray scale voltage to the second pixel A2, which may be represented as LP; loading a negative polarity high gray scale voltage to the third pixel A3, which can be represented as HN; loading a positive polarity high gray scale voltage to the fourth pixel A4, which can be expressed as HP; loading a positive low-gradation voltage to the fifth pixel A5, which can be expressed as LP; loading a negative low-gradation voltage to the sixth pixel A6, which can be expressed as LN; loading a positive polarity high gray scale voltage to the seventh pixel A7, which may be represented as HP; and loading the eighth pixel A8 with a negative polarity high gray scale voltage, which may be represented as HN.

In order to more clearly describe the above voltage loading relationship, from a certain column, the voltage relationship loaded for each sub-pixel in any column is expressed as follows: LN, LP, HN, HP, LN, LP, HN, HP . . . sequentially cycled or LP, LN, HP, HN, LP, LN, HP, HN . . . sequentially cycled; from a certain line, the voltage relationship loaded for each sub-pixel in any row is expressed as follows: LN, LP, HN, HP, LN, LP, HN, HP . . . sequentially cycled or LP, LN, HP, HN, LP, LN, HP, HN . . . sequentially cycled.

Or, loading a positive low-gradation voltage to the first pixel A1, which can be expressed as LP; loading a negative low-gradation voltage to the second pixel A2, which can be expressed as LN; loading a positive polarity high gray scale voltage to the third pixel A3, which can be represented as HP; loading the fourth pixel A4 with a negative polarity high gray scale voltage, which can be expressed as HN; loading a negative polarity low gray scale voltage to the fifth pixel A5, which can be represented as LN; loading the sixth pixel A6 with a positive low gray scale voltage, which can be expressed as LP; loading a negative polarity high gray scale voltage to the seventh pixel A7, which can be represented as HN; and loading a positive polarity high gray scale voltage to the eighth pixel A8, which can be expressed as HP.

In order to more clearly describe the above voltage loading relationship, from a certain column, the voltage relationship loaded for each sub-pixel in any column is expressed as follows: LP, LN, HP, HN, LP, LN, HP, HN . . . sequentially cycled or LN, LP, HN, HP, LN, LP, HN, HP . . . sequentially cycled; from a certain line, the voltage relationship loaded for each sub-pixel in any row is expressed as follows: LP, LN, HP, HN, LP, LN, HP, HN . . . sequentially cycled or LN, LP, HN, HP, LN, LP, HN, HP . . . sequentially cycled.

### Embodiment 9

Please also refer to FIG. 5D and FIG. 5E. In an optional 4×4 area, in the first column, the fifth pixel A5 and the thirteenth pixel A13 are connected to the first data line, in the second column, the first pixel A1, the sixth pixel A6, the ninth pixel A9, and the fourteenth pixel A14 are connected to the second data line, in the third column, the second pixel A2, the seventh pixel A7, the tenth pixel A10, and the fifteenth pixel A15 are connected to the third data line, in the fourth column, the third pixel A3, the eighth pixel A8, the eleventh pixel A11, and the sixteenth pixel A16 are connected to the fourth data line, in the fifth column, the fourth pixel A4 and the twelfth pixel A12 are connected to the fifth data line.

At the first moment in a frame, loading the scanning signal on the first scanning line, loading the voltage corresponding to the LN to the first pixel A1 on the second data line, loading the voltage corresponding to the LP to the second pixel A2 on the third data line, loading the voltage corresponding to the HN to the third pixel A3 on the fourth data line, loading the voltage corresponding to the HP to the fourth pixel A4 on the fifth data line, and so on;

at the next moment (the second moment), loading the scanning signal to the second row of scanning lines, loading the voltage corresponding to the LP to the fifth pixel A5 on the first data line, loading the voltage corresponding to the LN to the sixth pixel A6 on the second data line, loading the voltage corresponding to the HP to the seventh pixel A7 on the third data line, and loading the voltage corresponding to the HN to the eighth pixel A8 on the fourth data line;

at the next moment (the third moment), loading the scanning signal to the third row of scanning lines, loading the voltage corresponding to the HN to the ninth pixel A9 on the second data line, loading the voltage corresponding to the HP to the tenth pixel A10 on the third data line, loading the voltage corresponding to the LN to the eleventh pixel A11 on the fourth data line, loading the voltage corresponding to the LP to the twelfth pixel A12 on the fifth data line;

at the next moment (the fourth moment), loading the scanning signal to the fourth row of scanning lines, loading the voltage corresponding to the HP to the thirteenth pixel A13 on the first data line, loading the voltage corresponding to the HN to the fourteenth pixel A14 on the second data line, loading the voltage corresponding to the LP to the fifteenth pixel A15 on the third data line, loading the voltage corresponding to the LN to the sixteenth pixel A16 on the fourth data line. This scheme lists the voltage loading in the case of 4×4, and the other sub-pixels and other times are sequentially loaded with the corresponding voltages according to the above rules.

According to the above embodiment of the present invention, the side visibility can be improved by alternately loading the positive and negative polarity voltages and the high and low gray scale voltages to the pixel matrix. The pixels in the pixel matrix are not affected by the polarity, which improves crosstalk, bright and dark lines, and the like, and improves the display effect.

### Embodiment 10

Please refer to FIG. 4 again. A display device provided in this embodiment is suitable for performing the method for driving the pixel matrix of the foregoing sixth, eighth and ninth embodiments, including a timing controller 81, a data driving unit 82, a scan driving unit 83 and a display panel 84. The display panel 84 is provided with a pixel matrix 85. The pixel matrix 85 includes a plurality of sub-pixels arranged in a matrix, and the polarity of the data lines are exchanged once in each column along the scanning line direction. The voltage applied to the sub-pixels is inverted once every two sub-pixels in the data line direction, and the voltage applied to the sub-pixels is inverted once every sub-pixel polarity in the scanning line direction. The timing controller 81 is connected to the data driving unit 82 and the scan driving unit 83, the data driving unit 82 and the scan driving unit 83 are connected to the pixel matrix 85.

The timing controller 81 is configured to form first gray scale data and second gray scale data according to the original pixel data, and output the first gray scale data and the second gray scale data to the data driving unit 82.

The data driving unit 82 is configured to generate a first driving voltage according to the first gray scale data, and generate a second driving voltage according to the second gray scale data.

The scan driving unit 83 is configured to load a scanning signal to the pixel matrix 85.

Within one frame, the data driving unit 82 is further configured to load the first driving voltage corresponding to the first gray scale data or the second driving voltage corresponding to the second gray scale data to the pixel matrix 85 along a data line direction.

In a specific embodiment, the timing controller 81 is specifically configured to obtain an original pixel value of each pixel position according to the original pixel data, and convert the original pixel value of each pixel position into the first gray scale data or the second gray scale data according to a predetermined conversion manner.

The display panel 84 includes a plurality of data lines, a plurality of scanning lines, and a plurality of sub-pixels connected to the data lines and the scanning lines. The sub-pixels are arranged on the display panel in the data line direction and in the scanning line direction to form a pixel matrix 85, and the timing controller 81 inputs the RGB data signals of the image from the outside.

The timing controller 81 can input red image data R, green image data G blue image data B, or image data of other colors from the outside, and generate corresponding original pixel data according to the image data. And according to the above rules of the present invention, the original pixel data is corresponding to two sets of gray scale, high gray scale data and low gray scale data. The data driving circuit converts the high gray scale data and the low gray scale data into a corresponding high gray scale voltage and a low gray scale voltage by using a fixed gamma. The data driving unit 82 controls a specific output operation according to the above method of the present invention, and outputs an output of high gray scale, low gray scale, positive voltage, and negative voltage in accordance with timing correspondence.

In another embodiment, the display device is adapted to perform the method for driving the pixel matrix of the foregoing seventh, eighth, and ninth embodiments, and includes, for example, a timing controller 81, a data driving unit 82, a scan driving unit 83, and a display panel 84. The display panel 84 is provided with a pixel matrix 85. The pixel matrix 85 includes a plurality of sub-pixels arranged in a matrix, and the polarity of the data lines are exchanged once in each column along the scanning line direction. The voltage applied to the sub-pixels is inverted once every two sub-pixels in the data line direction, and the voltage applied to the sub-pixels is inverted once every sub-pixel polarity in the scanning line direction. The timing controller 81 is connected to the data driving unit 82, the scan driving unit 83, the data driving unit 82, the scan driving unit 83 are connected to the pixel matrix 85.

The timing controller 81 is configured to obtain original data driving signals of each pixel position according to the original pixel data.

The data driving unit 82 is configured to generate a first driving voltage and a second driving voltage according to the original data driving signals.

The scan driving unit 83 is configured to load a scanning signal to the pixel matrix 85.

Moreover, the data driving unit 82 is further configured to load the first driving voltage or the second driving voltage onto the pixel matrix 85 in a data line direction within one frame.

In a specific embodiment, the data driving unit 82 is further configured to obtain an original gray scale value and a conversion rule of a corresponding one of the corresponding pixel positions according to the original data driving signals, and convert the original gray scale value of the corresponding one of the pixel positions into the first driving voltage or the second driving voltage according to the conversion rule.

The timing controller 81 inputs image data from the outside, generates corresponding original pixel data according to the image data, and outputs the original data driving signals to the data driving circuit. Since the data driving circuit only receives the original gray scale value and the corresponding H or L conversion rule, the data driving circuit generates a high gamma high gray scale voltage and a low gamma low gray scale voltage through two different gamma correspondences. The data driving unit 82 controls a specific output operation according to the above method of the present invention, and selectively outputs a signal output of a high gray scale or a low gray scale, a positive voltage or a negative voltage according to different timings.

### Embodiment 11

Please refer to FIG. 2 again. In a method for driving the pixel matrix provided by the embodiment of the present invention, the pixel matrix includes a plurality of sub-pixels arranged in a matrix, and the polarity of the data lines is exchanged once in each column along the scanning line direction. The voltage applied to the sub-pixels is inverted once every two sub-pixels in the data line direction, and the voltage applied to the sub-pixels is reversed once every sub-pixel polarity in the scanning line direction; the methods include:

receiving an image data, and acquiring original pixel data according to the image data;

obtaining a first gray scale data and a second gray scale data according to the original pixel data;

generating the first driving voltage corresponding to the first gray scale data and the second driving voltage corresponding to the second gray scale data according to the first gray scale data and the second gray scale data; and

loading the first driving voltage or the second driving voltage onto the pixel matrix along the data line direction within one frame.

The image data refers to a digital signal input to the timing controller TCON, and the image data is input frame by frame, and the original pixel data is parsed by the image data. In one of the existing technologies, the original pixel data, that is, the specific pixel value corresponding to each sub-pixel in each pixel of the pixel matrix, the pixel value input to each sub-pixel is directly determined by the image data input into the TCON, and the original pixel data is not processed. Such methods are affected by the polarity of the sub-pixels, which causes the sub-pixel polarity to easily cause crosstalk, bright and dark lines and other negative effects.

In this embodiment, by processing the original pixel data, further first gray scale data and second gray scale data are obtained, and the first gray scale data is different from the gray scale of the second gray scale data, and is further loaded to the corresponding subpixels at different arrangement intervals between different pixels or different frames. The solution of this embodiment can generate two sets of different gray scales, corresponding to different sub-pixels, respectively. In this way, it is possible to prevent the voltage applied to the sub-pixel from being affected by the polarity reversed, thereby avoiding the occurrence of crosstalk and bright and dark lines.

In a specific example, the first gray scale data is considered to be high gray scale data, and the second gray scale data is considered to be low gray scale data, and correspondingly, the magnitude of the voltage input to the subpixel is determined by gray scale. Generating a high gray scale voltage corresponding to the high gray scale data, that is, the first driving voltage; and a low gray scale voltage corresponding to the low gray scale data, that is, the second driving voltage. It is worth mentioning that the above-mentioned high gray scale and low gray scale represent the relative values of the gray scale sizes of the two groups, and the magnitude of the values is not separately limited.

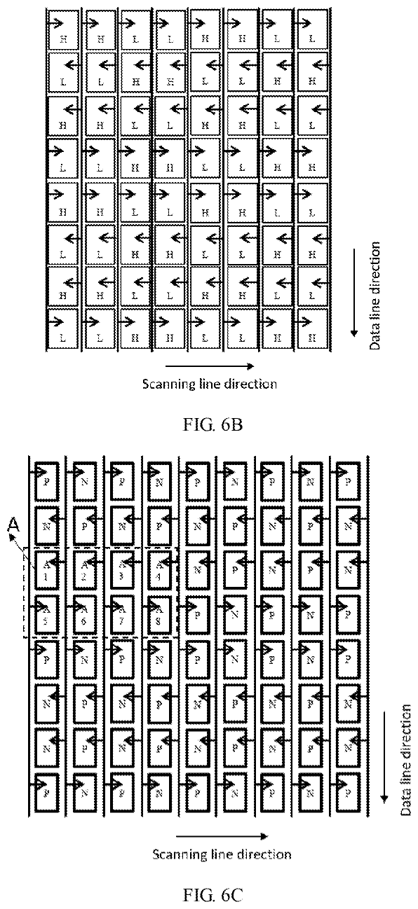

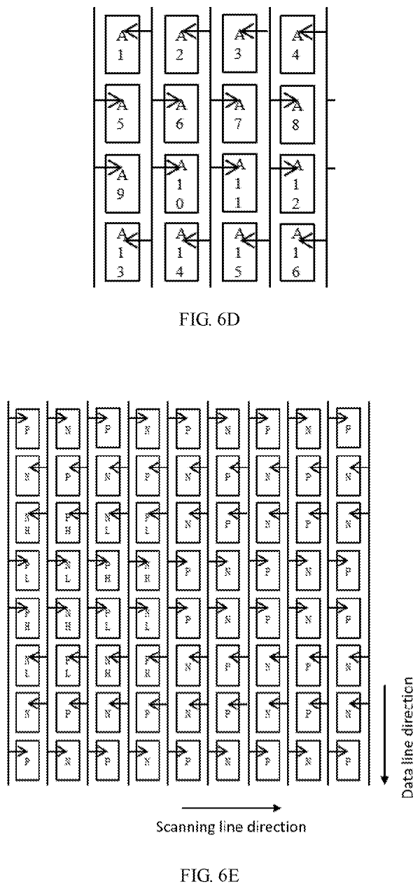

Please refer to FIG. 6A, the polarity of the data line is exchanged once in each column along the scanning line direction, and the polarity of the data line is a column reversed mode, and each column is exchanged once in the scanning line direction. By flipping the data lines along the data line, the polarity of the sub-pixels is exchanged once for the two sub-pixels along the data line direction, and the polarity of the sub-pixels is exchanged once for one sub-pixel along the scanning line direction. From a column, the two consecutive sub-pixels have the same polarity, and the next two consecutive sub-pixels have opposite polarities to the last two polarities. From a certain line, the sub-pixel polarity is alternately reversed, and so on. Overall, the voltage applied to the sub-pixels is inverted once every two sub-pixels in the data line direction, and the voltage applied to the sub-pixels is inverted once every sub-pixel polarity in the scanning line direction. In FIG. 3, P represents a positive voltage and N represents a negative voltage. From a certain column, the polarity transformation can be expressed as NNPP . . . NNPP or PPNN . . . PPNN. From a certain line, the polarity transformation can be expressed as PNPN . . . PNPN or NPNP . . . NPNP.

In a specific embodiment, obtaining the first gray scale data and the second gray scale data according to the original pixel data, including: obtaining an original pixel value of each pixel position according to the original pixel data, and converting original pixel value of each pixel position into first gray scale data or second gray scale data according to a predetermined conversion manner.

After determining the gray scale corresponding to each pixel position according to the rule of the present invention, the timing controller adjusts the original gray scale correspondence of the pixel position to a high gray scale or a low gray scale and sends the adjusted gray scale value to the data driving unit. The data driving unit outputs a corresponding voltage according to the gray scale value.

For example, the original pixel value of the A position is 128 gray scale, and according to the above rule of the present invention, the A position should output a high gray scale, that is, H, after calculation, in this example, 128 gray scale corresponding H=138 gray scale value, then output 138 gray scale to the A position, the data driving unit receives 138 gray scale, according to the established conversion rule, the voltage corresponding to 138 gray scale is 10V, and finally the voltage signal of 10V is output to the A position. Generally, the adjustment range of the high and low gray scales is determined by the difference of materials such as liquid crystal.

For another example, the original pixel value of the B position is 128 gray scale. According to the above rule of the present invention, the B position should output a low gray scale, that is, L, after calculation, in this example, the 128 gray scale corresponds to the L=118 gray scale value, then the output is 118 gray scale to the B position, and the data driving unit receives the 118 gray scale, according to the established conversion rules, the voltage corresponding to the gray scale of 118 is 8V, and finally the voltage signal of 8V is output to the B position.

In a specific embodiment, the step of loading of the first driving voltage corresponding to the first gray scale data or the second driving voltage corresponding to the second gray scale data in the data line direction according to a predetermined rule to the pixel matrix includes:

loading the first driving voltage or the second driving voltage to the pixel matrix alternately as per every other scanning line along a data line direction; and

loading the first driving voltage or the second driving voltage to the pixel matrix alternately as per every two data lines, along the scanning line direction.

The pixel matrix is physically divided into a plurality of small blocks arranged in a matrix by a plurality of interleaved data lines and scanning lines, each small block is a sub-pixel, and adjacent sub-pixels are divided by a corresponding one of the data lines or the scanning lines. As far as a column is concerned, different driving voltages are loaded between adjacent sub-pixels; or, in a row, different driving voltages are loaded between every two sub-pixels; they are alternately applied to the sub-pixels according to the above relationship.

Please refer to FIG. 6B, reference may be made to the following example. From a certain line, the gray scale voltages of two consecutive sub-pixels are the same, and the gray scale voltages of two consecutive sub-pixels loaded are different from the previous two, from a certain column, the gray scale voltages loaded into the sub-pixels are alternately transformed, and so on. In FIG. 4, H represents a high gray scale voltage, and L represents a low gray scale voltage, from a certain column, the polarity transformation can be expressed as HLHL . . . HLHL or LHLH . . . LHLH, from a certain line, the polarity transformation can be expressed as HHLL . . . HHLL or LLHH . . . LLHH.

The method for driving the pixel matrix of the invention is matched with the low gray scale voltage by a reasonable high gray scale voltage, so that the pixels in the pixel matrix are not affected by the polarity, and the problems such as crosstalk, bright and dark lines are avoided, and the display effect is improved.

### Embodiment 12

The embodiment of the invention simultaneously provides another method for driving a pixel matrix. The pixel matrix includes a plurality of sub-pixels arranged in a matrix, and the polarity of the data lines are exchanged once for each column in the scanning line direction. The voltage applied to the sub-pixels is inverted once every two sub-pixels in the data line direction, and the voltage applied to the sub-pixels is inverted once every sub-pixel polarity in the scanning line direction; the method includes:

receiving an image data, and acquiring original pixel data according to the image data;

obtaining original data driving signals for respective pixel positions according to the original pixel data;

obtaining a first driving voltage and a second driving voltage according to the original data driving signals; and

loading the first driving voltage or the second driving voltage onto the pixel matrix along a data line direction within one frame.

In a specific embodiment, obtaining the first driving voltage and the second driving voltage according to the original data driving signals, including: obtaining an original gray scale value and a conversion rule of a corresponding one of the corresponding pixel positions according to the original data driving signals, and converting the original gray scale value of the corresponding one of the pixel positions into the first driving voltage or the second driving voltage according to the conversion rule.

The timing controller of the present invention analyzes the original image, analyzes the original gray scale value of each pixel position, and determines a conversion rule corresponding to the position, and the conversion rule adjusts the original gray scale value to a high gray scale H or a low gray scale L. The method of the present invention does not directly perform gray scale conversion in the timing controller and sends the original gray scale value and the corresponding H or L conversion rule to the data driving unit. The data driving unit directly outputs the corresponding driving voltage according to the original gray scale value and the corresponding H or L according to the rule.

For example, in one embodiment, the original pixel value of the A position is 128 gray scales, and 128 gray scales are output for the A position. According to the conversion rule, the position of A should be H. After the driver circuit receives 128 gray scales, find the corresponding voltage 10V in the gray scale corresponding voltage conversion table of H, and finally output the driving voltage signal of 10V to the A position.

For example, the original pixel value of the B position is 128 gray scale. Then, for the B position output 128 gray scale according to the conversion rule B position should be L drive circuit receives 128 gray scale, find the corresponding voltage 8V in the gray scale corresponding pressure conversion table of L, and finally the 8V data signal is output to the A position.

In a specific embodiment, the first driving voltage or the second driving voltage is loaded onto the pixel matrix every other scanning line, along the data line direction;

the first driving voltage or the second driving voltage is loaded onto the pixel matrix every two data lines, along the scanning line direction.

In the method, the original pixel data of the embodiment corresponds to a set of gray scale values. In the data driving circuit, the original data driving signals corresponding to the gray scale value is generated, and the original data driving signals is adjusted to two different driving voltages. That is, the first driving voltage or the second driving voltage is output correspondingly. In this embodiment, by using two sets of different gammas to generate driving signals for driving sub-pixels, a set of original data driving signals are generated under different gamma to generate two sets of driving voltages, and then the driving control of the present invention is implemented. In a specific embodiment of the solution of the embodiment, the TCON outputs a set of gray scales, and the data driving circuit generates two sets of gammas, and each group respectively drives different sub-pixels, thereby achieving the same technical effect as the first embodiment.

### Embodiment 13

In a specific embodiment, in order to more clearly demonstrate the solution of the present invention, the pixel matrix includes a plurality of sub-pixel areas, and each of the sub-pixel areas includes:

a first sub-pixel;

a second sub-pixel adjacent to the first sub-pixel along a scanning line direction;

a third sub-pixel adjacent to the second sub-pixel along a scanning line direction;

a fourth sub-pixel adjacent to the third sub-pixel along a scanning line direction;

a fifth sub-pixel adjacent to the first sub-pixel along a data line direction;

a sixth sub-pixel adjacent to the second sub-pixel along a data line direction;

a seventh sub-pixel adjacent to the third sub-pixel along a data line direction;

an eighth sub-pixel adjacent to the fourth sub-pixel along a data line direction;

a first data line electrically connecting the fifth sub-pixel;

a second data line electrically connecting the first sub-pixel and the sixth sub-pixel;

a third data line electrically connecting the second sub-pixel and the seventh sub-pixel;

a fourth data line electrically connecting the third sub-pixel and the eighth sub-pixel; and

a fifth data line electrically connecting the fourth sub-pixel.

Referring to FIG. 6C, the area indicated by the mark A is represented as a sub-pixel area, and each sub-pixel area includes eight sub-pixels, which are divided into upper and lower lines, four sub-pixels per line. The first pixel A1, the second pixel A2, the third pixel A3, and the fourth pixel A4 are in a row, the fifth pixel A5, the sixth pixel A6, the seventh pixel A7, and the eighth pixel A8 are on the next line facing up. The pixel matrix is sequentially filled by a plurality of sub-pixel areas. The first data line is connected to the fifth pixel A5, the second data line is connected to the first pixel A1 and the sixth pixel A6, the third data line is connected to the second pixel A2, the seventh pixel A7, the fourth data line is connected to the third pixel A3, the eighth pixel A8, and the fifth data line is connected to the fourth pixel A4.

In a specific embodiment, the voltages applied to the first pixel A1, the third pixel A3, the sixth pixel A6, and the eighth pixel A8 have the same polarity and are opposite in polarity to the voltages applied to the second pixel A2, the fourth pixel A4, the fifth pixel A5, and the seventh pixel A7.

The voltage gray scales loaded onto the first pixel A1, the second pixel A2, the seventh pixel A7, and the eighth pixel A8 are different from the voltage gray scales loaded onto the third pixel A3, the fourth pixel A4, the fifth pixel A5, and the sixth pixel A6.

According to the above-mentioned cooperation relationship between the polarity of the voltage applied to the sub-pixel and the gray scale of the voltage, a specific embodiment is shown. Loading a negative high-gradation voltage to the first pixel A1 in one frame, which can be expressed as HN; loading a positive polarity high gray scale voltage to the second pixel A2, which can be expressed as HP; loading a negative low gray scale voltage to the third pixel A3, which can be expressed as LN; loading a positive low-gradation voltage to the fourth pixel A4, which can be expressed as LP; loading a positive low-gradation voltage to the fifth pixel A5, which can be expressed as LP; loading a negative polarity gray scale voltage to the sixth pixel A6, which can be expressed as LN; loading a positive polarity high gray scale voltage to the seventh pixel A7, which can be expressed as HP; and loading a negative polarity high gray scale voltage to the eighth pixel A8, which can be expressed as HN.

In order to more clearly describe the above voltage loading relationship, from a certain column, the voltage relationship loaded for each sub-pixel in any column is sequentially expressed as: HN, LP, HP, LN, HN, LP, HP, LN . . . sequentially cycledd or HP, LN, HN, LP, HP, LN, HN, LP . . . sequentially cycleds; from a certain line, the voltage relationship loaded for each sub-pixel in any row is sequentially expressed as: HN, HP, LN, LP, HN, HP, LN, LP . . . sequentially cycled or LP, LN, HP, HN, LP, LN, HP, HN . . . sequentially cycled.

Alternatively, loading a positive high gray scale voltage to the first pixel A1, which can be expressed as HP; loading a negative polarity high gray scale voltage to the second pixel A2, which can be expressed as HN; loading a positive low-gradation voltage to the third pixel A3, which can be expressed as LP; loading a negative polarity gray scale voltage to the fourth pixel A4, which can be expressed as LN; loading a negative low gray scale voltage to the fifth pixel A5, which can be expressed as LN; loading a positive low-gradation voltage to the sixth pixel A6, which can be expressed as LP; loading a negative polarity high gray scale voltage to the seventh pixel A7 which can be expressed as HN; and loading a positive polarity high gray scale voltage to the eighth pixel A8, which can be expressed as HP.

In order to more clearly describe the above voltage loading relationship, from a certain column, the voltage relationship loaded for each sub-pixel in any column is expressed as follows: HP, LN, HP, LN, HN, LP, HP, LN . . . sequentially cycled or HN, LP, HP, LN, HN, LP, HP, LN . . . sequentially cycled; from a certain line, the voltage relationship loaded for each sub-pixel in any row is expressed as follows: HP, HN, LP, LN, HP, HN, LP, LN . . . sequentially cycled or LN, LP, HN, HP, LN, LP, HN, HP . . . sequentially cycled.

In another embodiment, in a specific embodiment, the voltages applied to the first pixel A1, the third pixel A3, the fifth pixel A5, and the seventh pixel A7 are the same polarity, and the voltages applied to the second pixel A2, the fourth pixel A4, the sixth pixel A6, and the eighth pixel A8 are opposite in polarity. And the voltage gray scales loaded onto the gray scale on the first pixel A1, the second pixel A2, the seventh pixel A7, and the eighth pixel A8 are different from the voltage gray scales loaded onto the third pixel A3, the fourth pixel A4, the fifth pixel A5, and the sixth pixel A6. This driving method can regain the gray scale voltage relationship loaded on the pixel according to the above example, and will not be described again.

### Embodiment 14

Please refer to FIG. 6D and FIG. 6E together, in an optional 4×4 area, in the first column, the fifth pixel A5 and the ninth pixel A9 are connected to the first data line, in the second column, the first pixel A1, the sixth pixel A6, the tenth pixel A10, and the thirteenth pixel A13 are connected to the second data line, in the third column, the second pixel A2, the seventh pixel A7, the eleventh pixel A11, and the fourteenth pixel A14 are connected to the third data line, in the fourth column, the third pixel A3, the eighth pixel A8, the twelfth pixel A12, and the fifteenth pixel A15 are connected to the fourth data line, and in the fifth column, the fourth pixel A4 and the sixteenth pixel A16 are connected to the fifth data line.

At the first moment in a frame, loading a scanning signal on the first line scanning line, loading the voltage corresponding to the HN to the first pixel A1 on the second data line, loading the voltage corresponding to the HP to the second pixel A2 on the third data line, loading the voltage corresponding to the LN to the third pixel A3 on the fourth data line, loading the voltage corresponding to the LP to the fourth pixel A4 on the fifth data line, and so on;

at the next moment (the second moment), loading the scanning signal to the second row of scanning lines, loading the voltage corresponding to the LP on the first data line to the fifth pixel A5, loading the voltage corresponding to the LN to the sixth pixel A6 on the second data line, loading the voltage corresponding to HP to the seventh pixel A7 on the third data line, loading the voltage corresponding to the HN to the eighth pixel A8 on the fourth data line;

at the next moment (the third moment), loading the scanning signal to the third row of scanning lines, loading the voltage corresponding to the HP to the ninth pixel A9 on the first data line, loading the voltage corresponding to the HN to the tenth pixel A10 on the second data line, loading the voltage corresponding to the LP to the eleventh pixel A11 on the third data line, loading the voltage corresponding to the LN to the twelfth pixel A12 on the fourth data line;

at the next moment (the fourth moment), loading the scanning signal to the fourth row of scanning lines, loading the voltage corresponding to the LN to the thirteenth pixel A13 on the second data line, loading the voltage corresponding to the LP to the fourteenth pixel A14 on the third data line, loading the voltage corresponding to the HN to the fifteenth pixel A15 on the fourth data line, loading the voltage corresponding to HP to the sixteenth pixel A16 on the fifth data line. This scheme lists the voltage loading in the case of 4×4, and the other sub-pixels and other times are sequentially loaded with the corresponding voltages according to the above rules.

According to the above embodiment of the present invention, the side visibility can be improved by alternately loading the positive and negative polarity voltages and the high and low gray scale voltages to the pixel matrix. The pixels in the pixel matrix are not affected by the polarity, which improves crosstalk, bright and dark lines, and the like, and improves the display effect.

### Embodiment 15

Please refer to FIG. 4 again. a display device provided in this embodiment is suitable for performing the method for driving the pixel matrix of the eleventh, thirteenth and fourteenth embodiments, for example, including a timing controller 81, a data driving unit 82, a scan driving unit 83 and a display panel 84. The display panel 84 is provided with a pixel matrix 85. The pixel matrix 85 includes a plurality of sub-pixels arranged in a matrix, and the polarity of the data lines are exchanged once in each column along the scanning line direction. The voltage applied to the sub-pixels is inverted once every two sub-pixels in the data line direction, and the voltage applied to the sub-pixels is inverted once every sub-pixel polarity in the scanning line direction; the timing controller 81 is connected to the data driving unit 82 and the scan driving unit 83, the data driving unit 82 and the scan driving unit 83 are connected to the pixel matrix 85.

The timing controller 81 is configured to form first gray scale data and second gray scale data according to the original pixel data, and output the first gray scale data and the second gray scale data to the data driving unit 82.

The data driving unit 82 is configured to generate a first driving voltage according to the first gray scale data, and generate a second driving voltage according to the second gray scale data.

The scan driving unit 83 is configured to load a scanning signal to the pixel matrix 85.

Within a frame, the data driving unit 82 is further configured to load the first driving voltage corresponding to the first gray scale data or the second driving voltage corresponding to the second gray scale data to the pixel matrix 85 in a data line direction.

In a specific embodiment, the timing controller 81 is specifically configured to obtain an original pixel value of each pixel position according to the original pixel data, and convert the original pixel value of each pixel position into the first gray scale data or the second gray scale data according to a predetermined conversion manner.

The display panel 84 includes a plurality of data lines, a plurality of scanning lines, and a plurality of sub-pixels connected to the data lines and the scanning lines. The sub-pixels are arranged on the display panel in the data line direction and in the scanning line direction to form a pixel matrix 85, and the timing controller 81 inputs the RGB data signals of the image from the outside.

The timing controller 81 can input red image data R, green image data G blue image data B, or image data of other colors from the outside and generate corresponding original pixel data based on the image data, and cause the original pixel data to correspond to two sets of gray scale, high gray scale data and low gray scale data according to the above rules of the present invention. The data driving circuit converts the high gray scale data and the low gray scale data into a corresponding high gray scale voltage and a low gray scale voltage by using a fixed gamma. The data driving unit 82 controls a specific output operation according to the above method of the present invention, and outputs an output of high gray scale, low gray scale, positive voltage, and negative voltage in accordance with timing correspondence.

In another embodiment, the display device is adapted to perform the method for driving the pixel matrix of the aforementioned twelfth, thirteenth and fourteenth embodiments, which includes, for example, a timing controller 81, a data driving unit 82, a scan driving unit 83, and a display panel 84, the display panel 84 is provided with a pixel matrix 85. The pixel matrix 85 includes a plurality of sub-pixels arranged in a matrix, and the polarity of the data lines are exchanged once in each column along the scanning line direction. The voltage applied to the sub-pixels is inverted once every two sub-pixels in the data line direction, and the voltage applied to the sub-pixels is inverted once every sub-pixel polarity in the scanning line direction; the timing controller 81 is connected to the data driving unit 82 and the scan driving unit 83, the data driving unit 82 and the scan driving unit 83 are connected to the pixel matrix 85.

The timing controller 81 is configured to obtain original data driving signals of each pixel position according to the original pixel data.

The data driving unit 82 is configured to generate a first driving voltage and a second driving voltage according to the original data driving signals.

The scan driving unit 83 is configured to load a scanning signal to the pixel matrix 85.

Within one frame, the data driving unit 82 is further configured to load the first driving voltage or the second driving voltage onto the pixel matrix 85 along the data line direction.

In a specific embodiment, the data driving unit 82 is further configured to obtain an original gray scale value and a conversion rule of a corresponding one of the corresponding pixel positions according to the original data driving signals, and convert the original gray scale value of the corresponding pixel position into the first driving voltage or the second driving voltage according to the conversion rule.

The timing controller 81 inputs image data from the outside, generates corresponding original pixel data according to the image data, and outputs the original data driving signals to the data driving circuit. Since the data driving circuit only receives the original gray scale value and the corresponding H or L conversion rule, the data driving circuit generates a high gamma high gray scale voltage and a low gamma low gray scale voltage through two different gamma correspondences. The data driving unit 82 controls a specific output operation according to the above method of the present invention, and selectively outputs a signal output of a high gray scale or a low gray scale, a positive voltage or a negative voltage according to different timings.

The above is a further detailed description of the present invention in connection with the specific preferred embodiments, and the specific embodiments of the present invention are not limited to the description. It will be apparent to those skilled in the art that the present invention may be made without departing from the spirit and scope of the invention.

1. A method for driving a pixel matrix, the pixel matrix comprising a plurality of sub-pixels arranged in a matrix; wherein the method comprises:
receiving an image data, and acquiring original pixel data according to the image data;
generating a first driving voltage and a second driving voltage according to the original pixel data; and
loading the first driving voltage or the second driving voltage onto the pixel matrix along a data line direction within one frame.

2. The method according to claim 1, wherein the step of generating a first driving voltage and a second driving voltage according to the original pixel data comprises:
obtaining a first gray scale data and a second gray scale data according to the original pixel data; and
generating the first driving voltage corresponding to the first gray scale data and the second driving voltage corresponding to the second gray scale data according to the first gray scale data and the second gray scale data.

3. The method according to claim 2, wherein the step of obtaining a first gray scale data and a second gray scale data according to the original pixel data comprises:
obtaining an original pixel value of each pixel position according to the original pixel data, and converting the original pixel value of each pixel position into the first gray scale data or the second gray scale data according to a predetermined conversion manner.

4. The method according to claim 1, wherein the step of generating a first driving voltage and a second driving voltage according to the original pixel data comprises:
obtaining original data driving signals for respective pixel positions according to the original pixel data; and
obtaining the first driving voltage and the second driving voltage according to the original data driving signals.

5. The method according to claim 4, wherein the step of obtaining the first driving voltage and the second driving voltage according to the original data driving signals comprises:
obtaining an original gray scale value and a conversion rule of a corresponding one of the pixel positions according to the original data driving signals, and
converting the original gray scale value of the corresponding one of the pixel positions into the first driving voltage or the second driving voltage according to the conversion rule.

6. The method according to claim 1, wherein driving voltages applied to the sub-pixels are polarity reversed once every two sub-pixels in the data line direction, and the driving voltages applied to the sub-pixels are polarity reversed once every sub-pixel in a scanning line direction; and the step of loading the first driving voltage or the second driving voltage onto the pixel matrix along the data line direction within one frame comprises:
transmitting the first driving voltage or the second driving voltage to the pixel matrix alternately as per every scanning line, along the data line direction; and
transmitting the first driving voltage or the second driving voltage to the pixel matrix alternately as per every two data lines, along the scanning line direction.

7. The method according to claim 1, wherein a polarity of the data line is column reversed, and each column of sub-pixels alternately connect two adjacent data lines on both sides, voltages applied to the sub-pixels are polarity reversed once every sub-pixel in the data line direction, and the voltages applied to the sub-pixels are polarity reversed once every sub-pixel in a scanning line direction; the step of loading the first driving voltage or the second driving voltage onto the pixel matrix along a data line direction within one frame comprises:
transmitting the first driving voltage or the second driving voltage to the pixel matrix alternately as per every two scanning lines, along the data line direction; and
transmitting the first driving voltage or the second driving voltage to the pixel matrix alternately as per every two data lines, along the scanning line direction.

8. The method according to claim 1, wherein a polarity of the data line is column reversed, and each column of sub-pixels alternately connect two adjacent data lines on both sides, voltages applied to the sub-pixels are polarity reversed once every two sub-pixels in the data line direction, and the voltages applied to the sub-pixels are polarity reversed once every sub-pixel polarity in a scanning line direction; the step of loading the first driving voltage or the second driving voltage onto the pixel matrix along a data line direction within one frame comprises:
transmitting the first driving voltage or the second driving voltage to the pixel matrix alternately as per every scanning line, along the data line direction; and
transmitting the first driving voltage or the second driving voltage to the pixel matrix alternately as per every two data lines, along the scanning line direction.

9. A display device, comprising: a timing controller, a data driving unit, a scan driving unit and a display panel, wherein the display panel is provided with a pixel matrix, and the pixel matrix comprises a plurality of sub-pixels arranged in a matrix; the timing controller is connected to the data driving unit and the scan driving unit, the data driving unit and the scan driving unit are respectively connected to the pixel matrix;
the timing controller is configured to receive an image data, acquire original pixel data according to the image data, acquire a first gray scale data and a second gray scale data according to the original pixel data, and output the first gray scale data and the second gray scale data to the data driving unit;
the data driving unit is configured to generate a first driving voltage according to the first gray scale data, and generate a second driving voltage according to the second gray scale data;
the scan driving unit is configured to load a scanning signal to the pixel matrix; and
in a frame, the data driving unit is further configured to load the first driving voltage corresponding to the first gray scale data or the second driving voltage corresponding to the second gray scale data to the pixel matrix in a data line direction.

10. The display device according to claim 9, wherein the timing controller is specifically configured to obtain an original pixel value of each pixel position according to the original pixel data and convert the original pixel value of each pixel position into the first gray scale data or the second gray scale data according to a predetermined conversion manner.

11. The display device according to claim 9, wherein voltages applied to the sub-pixels are polarity reversed once every two sub-pixels in the data line direction, and the voltages applied to the sub-pixels are polarity reversed once every sub-pixel polarity in a scanning line direction.

12. The display device according to claim 9, wherein a polarity of the data line is column inversion, and each column of sub-pixels alternately connect two adjacent data lines on both sides, voltages applied to the sub-pixels are polarity reversed once every sub-pixel polarity in the data line direction, and the voltages applied to the sub-pixels are polarity reversed once every sub-pixel polarity in a scanning line direction.

13. The display device according to claim 9, wherein a polarity of the data line is column inversion, and each column of sub-pixels alternately connect two adjacent data lines on both sides, voltages applied to the sub-pixels are polarity reversed once every two sub-pixels in the data line direction, and the voltages applied to the sub-pixels are polarity reversed once every sub-pixel polarity in a scanning line direction.

14. A display device, comprising: a timing controller, a data driving unit, a scan driving unit and a display panel, wherein the display panel is provided with a pixel matrix, and the pixel matrix comprises a plurality of sub-pixels arranged in a matrix; the timing controller is connected to the data driving unit and the scan driving unit, the data driving unit and the scan driving unit are respectively connected to the pixel matrix;
the timing controller is configured to receive an image data, acquire original pixel data according to the image data, and obtain original data driving signals according to the original pixel data;
the data driving unit is configured to obtain a first driving voltage and a second driving voltage according to the original data driving signals;
the scan driving unit is configured to load a scanning signal to the pixel matrix; and
in a frame, the data driving unit is further configured to load the first driving voltage or the second driving voltage onto the pixel matrix in a data line direction.

15. The display device according to claim 14, wherein the data driving unit is further configured to obtain an original gray scale value and a conversion rule of a corresponding one of the corresponding pixel positions according to the original data driving signals, and convert the original gray scale value of the corresponding pixel position into the first driving voltage or the second driving voltage according to the conversion rule.

16. The display device according to claim 14, wherein voltages applied to the sub-pixels are polarity reversed once every two sub-pixels in the data line direction, and the voltages applied to the sub-pixels are polarity reversed once every sub-pixel polarity in a scanning line direction.

17. The display device according to claim 14, wherein a polarity of the data line is column inversion, and each column of sub-pixels alternately connect two adjacent data lines on both sides, voltages applied to the sub-pixels are polarity reversed once every sub-pixel polarity in the data line direction, and the voltages applied to the sub-pixels are polarity reversed once every sub-pixel polarity in a scanning line direction.

18. The display device according to claim 14, wherein a polarity of the data line is column inversion, and each column of sub-pixels alternately connect two adjacent data lines on both sides, voltages applied to the sub-pixels are polarity reversed once every two sub-pixels in the data line direction, and the voltages applied to the sub-pixels are polarity reversed once every sub-pixel polarity in a scanning line direction.
